(19) United States
(12) Patent Application Publication
(10) Pub. No.: US 2010/0139519 A1
(43) Pub. Date: Jun. 10, 2010

(54) SYSTEM OF AUTOMATIC TRANSPORT OF GOODS, BY MEANS OF ELECTRIC PLATFORMS ON MONORAIL, WITH SIDE STABILIZER

(76) Inventor: Gregorio Marquez Murillo, Madrid (ES)

Correspondence Address: GOTTLIEB RACKMAN & REISMAN PC, 270 MADISON AVENUE, 8TH FLOOR, NEW YORK, NY, 10016-0601, US

(21) Appl. No.: 12/514,315

(22) PCT Filed: Apr. 1, 2008
(86) PCT No.: PCT/ES2008/000194

§ 371 Date: Feb. 5, 2010

(30) Foreign Application Priority Data
Apr. 9, 2007 (ES) P200700924

(51) Int. Cl. B61B 13/04; B61B 1/00; G05D 1/00

(52) U.S. Cl. 104/119; 701/20

(57) ABSTRACT

System of automatic transport of goods, by means of electric platforms on monorail, with side stabilizer, whereof the platforms have a horizontal side stabilizer with corresponding power point, so that the general system comprises two monorails, for two-way transport with a central support structure between both rails which bears part of the stabilization device, the power point, rolling stock safety device and logistic support elements.

### OBJECT OF THE INVENTION

The present invention relates to a system for the automatic transport of goods by means of electric platforms running over a monorail, the platforms of which have a horizontal side stabilizer with its corresponding power connection.

The general systems consists of two monorails, an outgoing monorail and an incoming monorail, with a central support structure between both which has part of the stabilization device, the power connection elements and the logistic support and safety rolling device.

The field of the art referred to by the present invention is that of the transport of goods by fixed rails, although a specific application for people is not discarded.

### STATE OF THE ART AND BACKGROUND

The current technique for the transport of goods is mainly focused on transport by road. This means that the use of high-speed and diesel oil engines, for example 350 hp and 98 km. per hour, is contemplated, which engines are important causes of harmful emissions and global warming, of which they constitute a significant proportion.

These conditions together with traffic jams shared with automobiles generate a high specific consumption per ton-kilometer transported, which will not be sustainable in the near future and increases the cost of the economy of the transport sector.

The mortal accident rate in highways is related to the presence and type of current transport, in an approximate percentage of 13%.

The current state of transport demands a human effort and fatigue which considerably affects the work health of the sector. This is reflected in section 6.3.3.5 of the Strategic Transport Infrastructure Plan (Plan Estratégico de Infraestructuras del Trasporte, PEIT 2005-2020), which promotes incentives to drivers of a certain age so that they leave the profession.

Current infrastructures of this transport shared by automobiles and goods negatively affect transport economy due to the safety specifications in said structures. Viaducts and tunnels are an example of this.

There is evidently a considerable volume of transport of goods by traditional railway.

However, it has been proved that this system is slow and is too expensive because it is not very flexible. The system is very expensive and not very efficient while a train of sixty or seventy containers is not completely filled.

The urgent sending of containers is non-viable and it is necessary to resort to sending by road, the problems of which have already been described above, and without taking into account that the transport of people has preference, therefore the transport slowness is considerable in areas of one-way tracks.

The objectives of this invention contemplate the following as main objectives:
Reduction of the energy consumption per ton-kilometer transported due to the lower movement speed with direct effects on the aerodynamic resistance which is a function of the square of the speed and consequently, the power which is a function of the cube thereof.
Reduction of the energy consumption due to the lower monorail rolling resistance than the current one relating to rubber wheels on asphalt.
Reduction of global warming and CO2 emissions since it is an invention consuming electricity generated by natural gas combined-cycle plants, eliminating the consumption of diesel oil.
Collaboration in the objectives of lower accident rates on roads and highways due to a smaller presence of transport vehicles co-existing with the movement of people, carrying the goods separately by specific infrastructures.
Finally, cost reduction in the structures necessary for the same volume of tones transported, since the infrastructures necessary for this method are much more cost-effective than for a conventional railway.
Although there are some attempts to use monorails for the transport of both people and goods, no background document has been detected which solves the existing problem as effectively and economically as claimed in this invention

### DESCRIPTION OF THE INVENTION

The system is as a whole formed by a double T-shaped central support structure with an upper wing above which there is provided the installation of a conventional double rail over which a support and safety rolling device with its corresponding double safety railing would travel throughout the entire route.

Between the lower part of this upper wing of the central support structure and the upper part of the lower wing of this structure and in its inner part, there is the power connection of the transport platforms suitably protected by an insulating element and the main wheel of the articulated arm travels supported thereon.

The pneumatic wheels for the support and control of the articulated arm are supported at the lower part of the lower face.

This central structure is solidly anchored to the ground in the same place as the monorails.

Respective monorails over which the transport platforms will run are solidly anchored at a certain distance from the previously described central structure and symmetrically thereto.

The transport platforms are formed by rectangular frames prepared to transport in its upper part conventional containers in a safe and easy-to-handle manner.

In the lower and central part of these frames there are several aligned wheels in the rolling direction which travel on the monorail.

This set of wheels has an efficient suspension system, shock absorption system and equipment of brakes installed in frames for such purpose.

One of the wheels, called drive wheel, is connected with an electric motor to drive the movement of the assembly over the monorails, by pinion-crown transmission which in turn acts as a reducer.

A horizontal stabilizing arm emerges from a side of the transport platform, at the end of which arm there is observed the electric contact connection, more towards the inside the main pneumatic wheel running between the wings of the central structure and there being two auxiliary wheels which by means of articulated connecting rods and taking as a rolling path the lower part of the lower wing of the central structure, both wheels having a conversion spring such that the main pneumatic wheel remains adhered to its rolling surface, a contact force being created in the upward direction.

The stability of the platform is therefore obtained by means of the stabilizing arm such that the three pneumatic wheels, the main and the auxiliary wheels, due to the effect of the aforementioned compression spring and due to the design condition caused by the load (effect of weight in a downward direction) assure the permanent contact of the main pneumatic wheel on the rolling surface with a given force (E). And for a greater safety and for the force of the thrust to always be positive downwards, it is provided that the vertical axis of the set of wheels is slightly offset from the axis of symmetry of the platform, towards the opposite side of the stabilizing arm. There is thus a controlled overturning torque coming from the load and weight of the platform assuring the positive value of the reaction of the force “E”.

### DESCRIPTION OF THE DRAWINGS

Four sheets of drawings are attached to better understand the proposed invention, in which the same numbers identifies the same element and in which the following is distinguished:
(1)—Platform
(2)—monorail.
   (3)—anchor of the monorail to the ground.
(4)—aligned wheels.
(5)—electric motor.
(6)—pinion-crown transmission.
(7)—electric brakes.
(8)—suspension system.
(9)—hydraulic shock absorbers.
(10)—container.
(11)—stabilizing arm
(12)—main wheel.
(12b)—rolling surface.
(13)—pneumatic wheels.
(14)—articulated connecting rods.
(15)—compression spring.
(15′)—mobile contact connection
(16)—insulators.
(16′)—power connection
(17)—frame for the brakes.
(18)—electric-electronic panel.
(19)—upper passage for the central support structure.
(32)—central support structure.
(33)—upper wing of the central support structure.
(20)—rolling surface of the lower face of the upper wing
(34)—lower wing of the central support structure.
(35)—upper rolling path of the lower wing.
(36)—lower rolling path of the lower wing.
(37)—maintenance passage rails.
(38)—safety railings.
(39)—support and safety rolling device.

FIG. 1 shows a side view of the platform, wheels and support monorail.

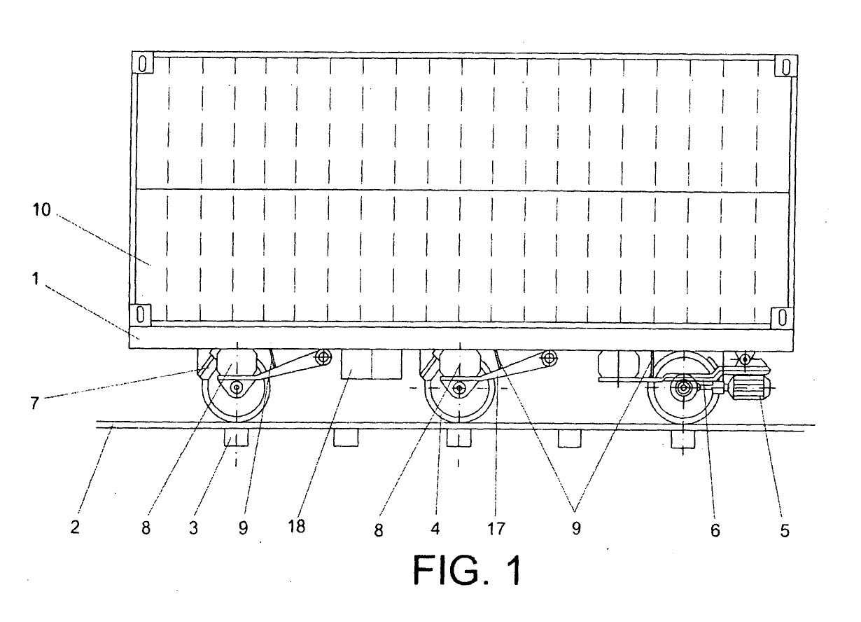

FIG. 2 shows a side elevational and upper view of the stabilizing arm.

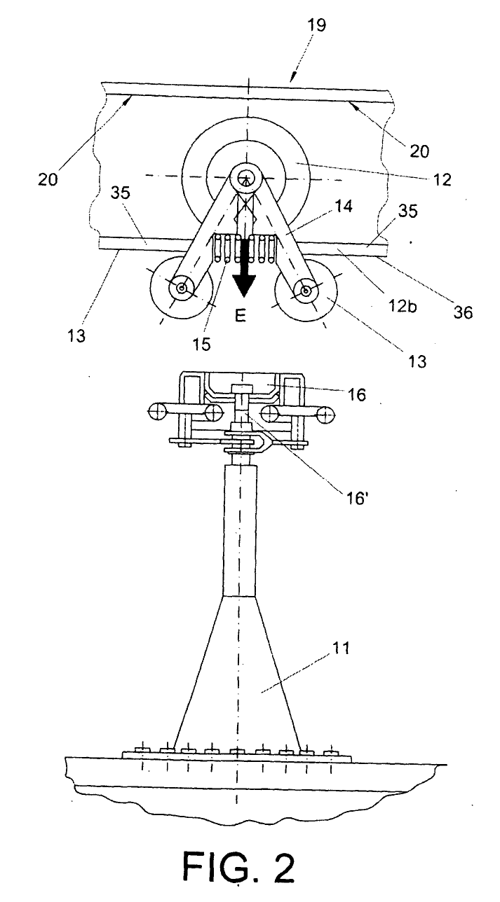

FIG. 3 shows a section view of the central support structure with the stabilizing arms in their work position.

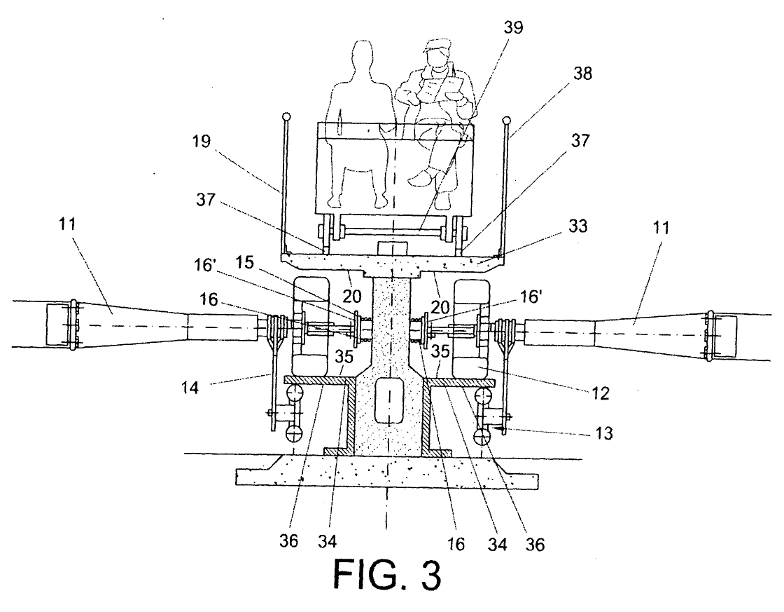

FIG. 4 shows a section view of the complete device in a work position.

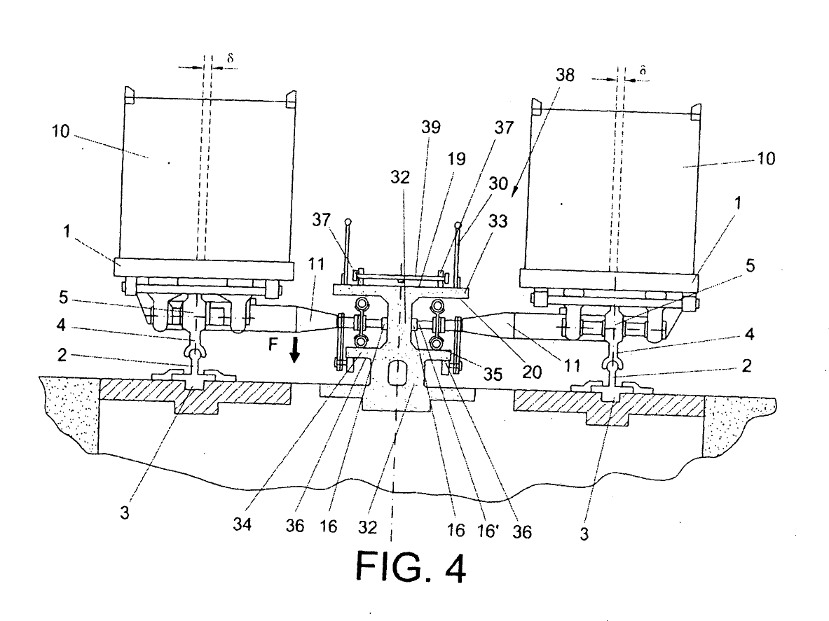

### PREFERRED EMBODIMENT OF THE INVENTION

One of the present embodiments of the proposed invention is formed from a central support structure (32) adopting a double T shape with an upper wing (33) the upper part (35) of which is formed as a rolling path and at which the installation of a conventional double rail (37) is provided and over which a support and safety rolling device (39) with its corresponding double safety railing (38) would travel throughout the entire route. This rolling device (39) can be conventional mobile device moved preferably by diesel oil so that it can serve as support and aid in the event of a power failure in the system.

Between the lower part (20) of this upper wing (33) of the central support structure and rolling path corresponding to the upper part of the lower wing (34) of this structure there is, in its inner part, the power connection (16′) of the transport platforms suitably protected by an insulating element (16) and the main pneumatic wheel (13) of the articulated arm (11) travels supported on both rolling surfaces.

The pneumatic wheels (13) for the support of the articulated arm (11) are supported at the rolling path corresponding to the lower face (36) of the lower wing (34).

This central support structure (32) is solidly anchored to the ground in the same place as the monorails.

Respective monorails (2) over which the transport platforms (1) will run are solidly anchored by means of shoes (3) at a certain distance from the previously described central support structure (32) and symmetrically thereto.

The transport platforms (1) are formed by rectangular frames prepared to transport in their upper part conventional containers (10) in a safe and easy-to-handle manner.

In the lower and central part of these platforms (1) there are several aligned wheels (4) in the rolling direction which travel on the monorail (2)

This set of wheels (4) has an efficient suspension system (8) and a shock absorption system (9), formed by independent hydraulic shock absorbers which are proportional in number and location to the load and its distribution and an equipment of electric brakes (7) preferably installed in frames (17) located for such purpose.

One of the aligned wheels (4) will be the so-called drive wheel since it is connected with an electric motor (5), the objective of which is to drive the movement of the assembly over the monorails, by pinion-crown transmission (6) which in turn acts as a reducer.

The horizontal stabilizing arm (11) emerges from a side of the transport platform, at the end of which arm there is observed the mobile contact connection (15′), which will tap current for the assembly by means of the power connection (16′).

The main pneumatic wheel (12) running between the wings (33) and (34) of the central support structure (32) is located more towards the outside of the stabilizing arm (11) and there being two auxiliary wheels (13) supported by means of articulated connecting rods (14) even more towards the outside.

Said auxiliary wheels (13) have as a rolling path the lower part of the lower wing (35) of the central support structure, both wheels further having a conversion spring (15) such that it forces the main pneumatic wheel (12) to remain adhered to its rolling surface, a contact force being created in the upward direction.

The stability of the platform (1) is therefore obtained by means of the stabilizing arm (11) such that the three pneumatic wheels, the main wheel (12) and auxiliary wheels (13), due to the effect of the aforementioned compression spring and due to the design condition caused by the load (effect of weight in a downward direction) assure the permanent contact of the main pneumatic wheel (12) on the rolling surface with a given force (E). And for a greater safety and for the force of the thrust to always be positive downwards, it is provided that the vertical axis of the set of wheels (4) is slightly offset from the axis of symmetry of the platform, towards the opposite side of the stabilizing arm. It is considered that a distance of 10 cm. between both axes is enough to achieve an optimal stabilization effect. There is thus a controlled overturning torque coming from the load and weight of the platform assuring the positive value of the reaction of the force “E”.

The stability of the assembly in the different operative conditions is determined by the calculated values of the load E, where it could be the following by way of an illustrative example:
Eight tn. of load well distributed at rest or linear movement, results in E=1,600 kg.

Eight tn. of load offset 15% at rest or linear movement, results in =750 kg.
Eight tn. in curve or radius 200 m. involves a 5° cant, results in a load of 1,600 kilos.

The transport of goods thus functionally described is considered to have an optimal efficiency when it is formed by a series of independent platforms separated from one another by a programmable distance according to the line loads which will frequently be of 85 metros between platforms.

The drive assembly must provide the suitable transport speed which, the most suitable one being a speed of approximately 50 km. per hour, is equal to a distance of 1,200 km. per day.

In relation to the electric motor (5), for a homogeneous result it has been provided with 100 kW (130 hp) of voltage 3,000 V and is of the induction asynchronous type, with electronic power regulation capable of automatically following the control from the signals emitted by the operation program of each platform and which is received in the electric-electronic panel (18) located in each platform (1).

Likewise, it has been considered that the transmission to the front drive wheel of the platform (1) is preferably carried out by the epicycloidal Gleason-type pinion-crown system (6).

In relation to the electric brakes (7), electric EBS brakes, in combination with disk brake with force limiter according to the signals received from the conventional ABS device also provided in the assembly, are considered as suitable.

It has been calculated that the suitable size for the brake pads must have a surface area of at least 150 cm².

The suspension system (8) is considered to be of the compressed air cushion-type, with a pressure and height which can be regulated according to the load, and the shock absorption (9) is preferably considered as of hydraulic shock absorbers.

For a better operation of the assembly and for the automation to really be effective, an automatic brake, stop and acceleration system has been designed.

This system is controlled by an operative program which is located in the electric/electronic panel (18) located in the platform (1), said program being designed to carry out said operations as follows:

The platform braking operation for unloading or loading is started by means of a signal received at 85 m. before the container reaches the destination station. After that instant, the regulation of hydraulic pressure is started which activates the disk brakes, causing a constant deceleration regime which, hooking the container by means of four hooks, moves it over a path of rollers leading it to the transient waiting docks until the arrival of the corresponding truck which removes the goods.

During the time of that operation, the platform is fixed by means of an electric brake which is deactivated when the platform is released from its load or has a received a new one.

After that instant, the electric motor launches the platform with an also constant acceleration until reaching the cruise speed established in 50 km. per hour.

The braking and accelerating operations are carried out in the space of seconds. As an illustrative example to facilitate understanding, the following empirical data of this system are mentioned:

Braking distance=85 m.

Launching distance=170 m.

Braking time=11 s.

Launching time=22 s.

Braking deceleration=1.4 m/s²

Launching acceleration=0.7 m/s²

It has been empirically verified that these operations can be carried out perfectly without exceeding the maximum coefficient of friction/wheel of the monorail.

The containers, perhaps not more than 4 in number, after the container which must carry out the stop also start a prior deceleration by means of the system of keeping the programmed distances for that operation, which result in a decrease in speed without stopping, maintaining a speed of the order of 5 m. per second (17 km. per hour), giving with this delay enough time to unload the platform which will stop.

Once the unloading and/or the loading is carried out, all the containers start their acceleration until reaching the cruise speed again.

The utilization for energy purposes is one of the most positive consequences of this invention.

The consumption of natural gas as primary energy generating electricity to power the motors of the system producing the mechanical energy used results in an overall efficiency of the two transformations of 0.522, as a product of the efficiency of the electric motor, 0.9, and that of the generating power station, 0.58.

The assessment of this result against that of the current state of the art, of a diesel oil engine results in a positive balance, the main reason for this invention, of 890 million kilowatts-hour for a hypothesis of 10 million tons per year in 100 km. of incoming and outgoing line.

In addition, the environmental impact in CO2 emissions with identical considerations leads to a lower emission of 300,000 tn. per year. It has been taken into account that diesel oil emits 72 kg. per CO2 per GJ generated, compared to natural gas which emits 54 kg. per GJ.

The permanent inspection and minor maintenance can be carried out by inspectors and operators moving over the line on a maintenance and safety rolling device (39).

For greater breakdowns which force stopping the line, there is the aid of a helicopter which can transport operators, repair material or, where appropriate, removing the container and platform which are the cause of said breakdown from the line.

In each intermediate station there can be a repair workshop and heliport for this emergency service.

Having sufficiently described the nature of the invention as well as the way of putting it into practice, it must be stated that the arrangement previously indicated and depicted in the attached drawings are susceptible to modifications of detail provided that they do not alter its essential principles, established in the previous paragraphs and summarized in the following, claims.

1. A system for the automatic transport of goods by means of electric platforms on a monorail with a side stabilizer, characterized by being formed from a central support structure adopting a double T shape with an upper wing an upper part of which is formed as a rolling path and at which installation of a conventional double rail is provided and over which a support and safety rolling device with corresponding double safety railing would travel throughout the entire route and wherein between a lower part of this upper wing of the central support structure and rolling path corresponding to an upper part of a lower wing of this structure, in its inner part, there is a power connection of the transport platforms suitably protected by an insulating element and a main pneumatic wheel, of an articulated arm, travels supported on both rolling surfaces and wherein pneumatic wheels for support of the articulated arm are supported at the rolling path corresponding to a lower face of the lower wing.

2. The system for the automatic transport of goods by electric platforms on a monorail with a side stabilizer according to claim 1 and characterized in that respective monorails over which transport platforms will run are solidly anchored to the ground by shoes at a certain distance from the central support structure and symmetrically thereto, these transport platforms, being formed by conventional rectangular frames, prepared to transport in their upper part conventional containers and there being in the lower and central part of these platforms several aligned wheels in the rolling direction which travel on the monorail and wherein this set of wheels has an efficient suspension system, shock absorption system, formed by independent hydraulic shock absorbers which are proportional in number and location to the load and its distribution and electric brakes, preferably installed in frames located for such purpose.

3. The system for the automatic transport of goods by electric platforms on a monorail with a side stabilizer according to claim 2 and characterized in that one of the aligned wheels will be a drive wheel since it is connected with an electric motor to drive the movement of the assembly over the monorails, by pinion-crown transmission which acts as a reducer.

4. The system for the automatic transport of goods by electric platforms on a monorail with a side stabilizer according to claim 3 and characterized in that a horizontal stabilizing arm emerges from a side of the transport platform, at the end of which arm there is a mobile contact connection, which will tap current for the assembly by a power connection, located in the central support structure, and wherein the main pneumatic wheel running between the rolling paths of the wings of the central support structure is located more towards the outside of the stabilizing arm and two auxiliary wheels supported by the articulated connecting rods being located even more towards the outside, and wherein said auxiliary wheels have as a rolling path the lower part of the lower wing of the central support structure, both wheels having a conversion spring that forces the main pneumatic wheel to remain adhered to its rolling surface, a contact force being created in the upward direction.

5. The system for the automatic transport of goods by electric platforms on a monorail with a side stabilizer according to claim 4 and characterized in that the stability of the platform is obtained by means of the stabilizing arm such that the three pneumatic wheels, the main wheel and auxiliary wheels, due to the effect of the aforementioned compression spring and due to the design condition caused by the load (effect of weight in a downward direction assure the permanent contact of the main pneumatic wheel on the rolling surface with a given force, and wherein for greater safety and for the force of the thrust to always be positive downwards, it is provided that the vertical axis of the wheels is slightly offset from the axis of symmetry of the platform, towards the opposite side of the stabilizing arm.

6. The system for the automatic transport of goods by electric platforms on a monorail with a side stabilizer according to claim 1 and characterized in that for the automation of the transport to work, it comprises an automatic brake, stop and acceleration device, controlled by an operative program which is located in an electronic panel located in the platform such that the platform braking operation for unloading or loading is started by a signal received at 85 meters before the platform supporting the container reaches its destination station, the regulation of hydraulic pressure activating electric brakes being started after that instant, causing a constant deceleration while the container is hooked by four hooks, and moves over a path of rollers leading it to the transient waiting docks until the arrival of the corresponding truck which removes the goods, whereas during the time of that operation, the platform (1) is fixed by an electric brake which is deactivated when the platform is released from its load or has received a new load, and after that instant, the electric motor launches the platform with a constant acceleration until reaching a cruise speed established in 50 kilometers per hour, such that the containers after the container which must carry out the stop also start a prior deceleration by the system of keeping the programmed distances for that operation, which result in a decrease in speed without stopping, maintaining a speed of the order of 5 meters per second, giving with this delay enough time to unload the platform which will stop.
